(19) United States
(12) Patent Application Publication
(10) Pub. No.: US 2018/0324230 A1
(43) Pub. Date: Nov. 8, 2018

(54) SYSTEM AND METHOD FOR DIGITAL CONTENT BROADCASTING TO SUBSCRIBERS IN A NETWORK

(71) Applicant: Inshorts Medialabs Private Limited, Delhi (IN)

(72) Inventors: Manish BISHT, Noida (IN); Deepit PURKAYASTHA, Noida (IN); Anunay PANDEY, Noida (IN); Azhar IQUBAL, Noida (IN); Gaurav PHULWARIA, Noida (IN); Sourav DE, Noida (IN); Salaam THOMAS, Noida (IN); Saalis UMER, Noida (IN); Ravi SINGH, Noida (IN)

(73) Assignee: Inshorts Medialabs Private Limited

(21) Appl. No.: 15/585,795

(22) Filed: May 3, 2017

(51) Int. Cl. H04L 29/06; H04L 12/58; H04L 29/08

(52) U.S. Cl. CPC H04L 65/4076; H04L 51/32; G06F 3/0488; H04L 67/02; H04L 67/306

(57) ABSTRACT

The present disclosure relates to a method for broadcasting a digital content among a plurality of computing devices of users on a single tap or click, the plurality of users are subscribed to a digital content service provider. The method comprises the steps of generating a digital content via a digital content server, transmitting the said digital content to a computing device of a first user, presenting the said transmitted digital content on the computing device of the first user, receiving a request from a computing device of a first user to broadcast the digital content, fetching contact information for one or more users based on a predefined criteria and broadcasting the digital content to the computing devices of the fetched one or more users.

### FIELD OF THE DISCLOSURE

The field of the present disclosure relates to system and method for digital content broadcasting in a communication network. More specifically, the present disclosure provides system and method for broadcasting a digital content to a plurality of user computing devices, wherein the plurality of user computing devices are subscribed to a content service provider.

### BACKGROUND OF THE DISCLOSURE

In this 21^{st} century, use of mobile phones and other computing devices has become very common to the mankind. There has been a tremendous increase in the number of mobile users across the world. Such devices have become an integral part of the lives of human beings.

These computing devices find varied usage such as playing games, surfing internet, capturing pictures, social media networking, and much more. Among the varied usages of these devices, people have become more interested towards sharing of digital contents to their friends, colleagues, family, etc. Especially, in this knowledge driven world, there has been a growing propensity among people to share news content with others.

There are many content providers available in the market for providing digital contents which a user/person would like to view, read, watch and share. Content providers provide a variety of content, be it the current news related to business, sports, politics, technology, entertainment, science and much more. There are endless possibilities of contents which a user would like to read and share.

Especially, there have been a growing number of news content providers who aim at providing news content quickly and in the most efficient manner. The inventors of the present patent application are among the pioneers of providing news content to users. They are creators of a new category of news content, called short news content, wherein concise 60 words summary of long news items are provided to users using their mobile applications installed on smart phones.

This new category of news items is growing popular among the users. The users find it attractive because of many reasons. One of the important reasons is the ease of reading the short and to the point news rather than a lengthy and opinionated analysis. This saves a lot of time for the user, and in the fast paced and short retention times it is highly welcome. Therefore, there is a need for developing advanced systems and methods for sharing of digital content, especially news content, in a communication network such that the recipient views the news content in totality and is not required to go through hyperlinks for reading/viewing the content.

Further, there is a need to develop systems and methods for efficiently sharing such news content among various subscribers to their service so that the news content could be transmitted among various users to that service without intervention from the service provider.

### SUMMARY OF THE DISCLOSURE

The general purpose of the present disclosure is to provide a system and method for digital content broadcasting among a plurality of users having computing devices configured with a software application (execution program) capable of receiving and presenting the digital content in the predefined digital format.

To achieve the above objectives and to fulfill the identified needs, in one aspect, the present disclosure provides a method for digital content broadcasting among a plurality of users having computing devices, the plurality of users are subscribed to a content service provider.

In an embodiment, the said method comprises generating a digital content via a digital content server, the said digital content generated in a predefined digital format, transmitting the said digital content to a computing device of a first user; presenting the said transmitted digital content on the computing device of the first user, the presenting being done in the predefined digital format, receiving a request from a computing device of a first user to broadcast the digital content to one or more of the plurality of computing devices of users, fetching contact information for one or more users associated with the first user, wherein the fetching is based upon predefined criteria, and broadcasting the digital content to the computing devices of the fetched one or more users.

In an embodiment of the present disclosure, the digital content is a short news content comprising a summary of a larger news content. The short news content may comprise an image, a headline of the news, and the summary of the news item.

In another embodiment, the digital content includes at least one textual content, an image content, a video content, an audio content, or a Graphics Interchange Format (GIF).

In an embodiment of the present disclosure, the computing device is a smart phone of the first user, and the set of predefined criteria includes transmitting the digital content to the one or more of the plurality of users whose contact information are stored in contact database of the smart phone of the first user.

In another embodiment of the present disclosure, the set of predefined criteria comprises transmitting the digital content to the one or more of the plurality of users who are in social media contacts of the first user. In this embodiment, the social media contacts are Facebook contacts and Twitter contacts, or other contacts in other social media of the first user.

In an aspect, the present disclosure provides a system for broadcasting a digital content among a plurality of users subscribed to the services provided by a service.

The said system comprises a plurality of computing devices capable of being operated by the users, each computing device comprising an execution program for receiving and presenting the digital content, and a digital content server.

The said digital content server is communicably coupled to the plurality of computing device of users, the digital content server comprises one or more processors adapted to execute instructions for, generating a digital content via a digital content server, the said digital content generated in a predefined digital format, transmitting the said digital content to a computing device of a first user; presenting the said transmitted digital content on the computing device of the first user, the presenting being done in the said predefined digital format, receiving a request from a computing device of the first user to broadcast the digital content to one or more of the plurality of computing devices of users, fetching contact information for one or more users wherein the one or more users are associated with the first user, wherein such that the fetching is based upon predefined criteria, and broadcasting the digital content to the computing devices of the fetched one or more users.

In an aspect of the present disclosure, the digital content server is adapted to generate the digital content in the said predefined digital format, the digital content being generated from information available on the World Wide Web.

This together with the other aspects of the present disclosure along with the various features of novelty that characterized the present disclosure is pointed out with particularity in claims annexed hereto and forms a part of the present disclosure. For better understanding of the present disclosure, its operating advantages, and the specified objective attained by its uses, reference should be made to the accompanying descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawing, in which:

FIG. 1 illustrates a block diagram of a system for implementation of the digital content broadcasting method, according to various embodiments of the present disclosure;

FIG. 2 illustrates a digital content as displayed on a computing device of a user, according to various embodiments of the present disclosure;

FIG. 3A illustrates a schematic diagram of broadcasting the content to one or more of the plurality of users, according to various embodiments of the present disclosure;

FIG. 3B illustrates an exemplary table (in continuation of FIG. 3A) summarizing the selection of one or more of the plurality of users to whom a news content is to be broadcasted, according to various embodiments of the present disclosure;

FIG. 3C illustrates an exemplary embodiment with respect to notification feed for digital contents being received on the computing devices of the users, according to an embodiment of the present disclosure;

FIG. 4 illustrates an example showing the mutual relationship between users for sharing/broadcasting the news content, according to an embodiment of the present disclosure;

FIGS. 5A and 5B illustrate an example showing the mutual relationship among users in respect of social media platforms such as Facebook, Twitter etc., according to an embodiment of the present disclosure;

FIG. 6 illustrates a flowchart explaining the method for digital content broadcasting, according to various embodiments of the present disclosure;

FIG. 7 illustrates a flowchart for the method for selection of contacts from a contact database for broadcasting a digital content, according to various embodiments of the present disclosure; and

FIG. 8 illustrates the architecture of a computing device being used by a user, according to various embodiments of the present disclosure.

Like numerals refer to like elements throughout the present disclosure.

### DETAILED DESCRIPTION OF THE DISCLOSURE

The foregoing descriptions of specific embodiments of the present disclosure have been presented for purposes of illustration and description. They are not intended to be exhaustive or to limit the disclosure to the precise forms disclosed, and obviously many modifications and variations are possible in light of the above teaching. The exemplary embodiment was chosen and described in order to best explain the principles of the disclosure and its practical application, to thereby enable others skilled in the art to best utilize the disclosure and various embodiments with various modifications as are suited to the particular use contemplated.

The terms “a” and “an” herein do not denote a limitation of quantity, but rather denote the presence of at least one of the referenced item.

The terms “having”, “comprising”, “including”, and variations thereof signify the presence of a component.

The term “communication network” relates a network of computing devices which are capable of communicating with each other via the internet.

The term “computing device” relates to electronic devices such as mobile phones, smart phones, laptops, desktops, tablets and the like.

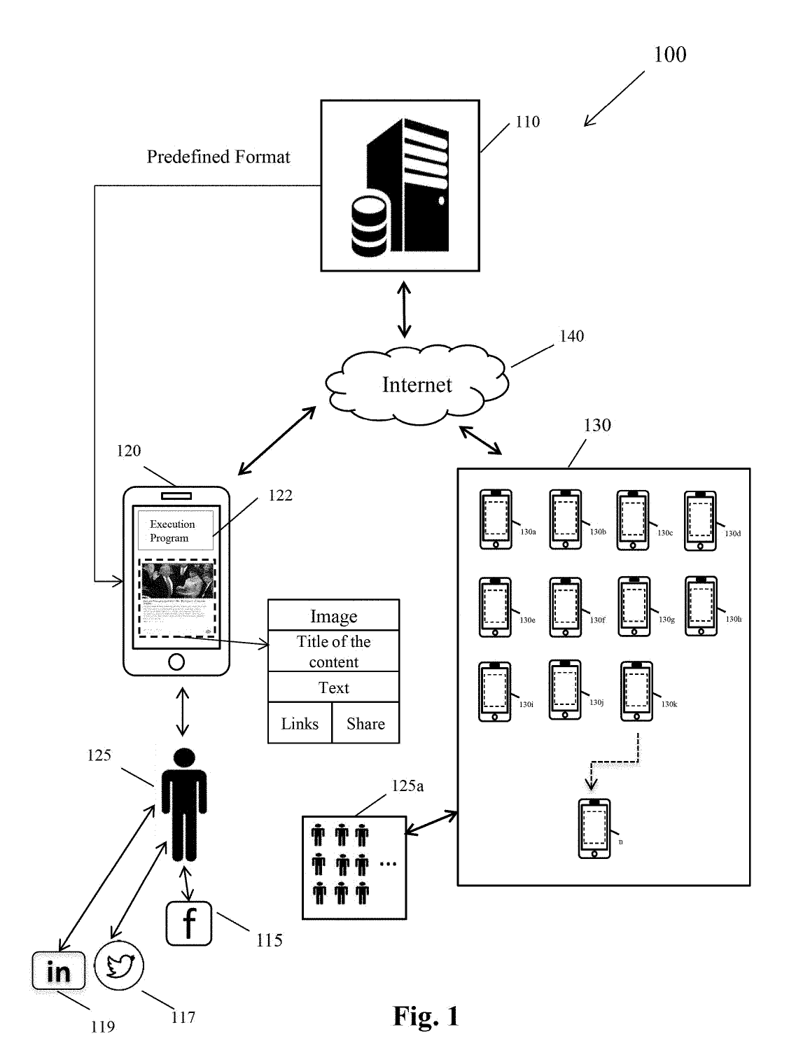

The present disclosure relates to a method for digital content broadcasting among a plurality of users having computing devices. The plurality of users are subscribed to the services provided by a content service provider and have software application installed in the computing devices capable of accessing the digital content in a predefined format. The said systems and methods shall now be explained in conjunction with FIGS. 1 to 8.

The terms “digital content server” and “content service provider” are being used interchangeably throughout the description.

The terms “digital content” and “news content” and “short news content” are being used interchangeably throughout the description.

The term “contacts” or “contact information” relate to the mobile number or social media account information associated with the one or more of the plurality of users.

In one embodiment of the disclosure, the term digital content specifically refers to news content, and more specifically, to short news content (also referred to as “news content”) comprising a concise summary of larger news content. Accordingly, present systems and methods provide means for broadcasting such short news content to various subscribers of short news service in a communication network with a single tap or click by a user.

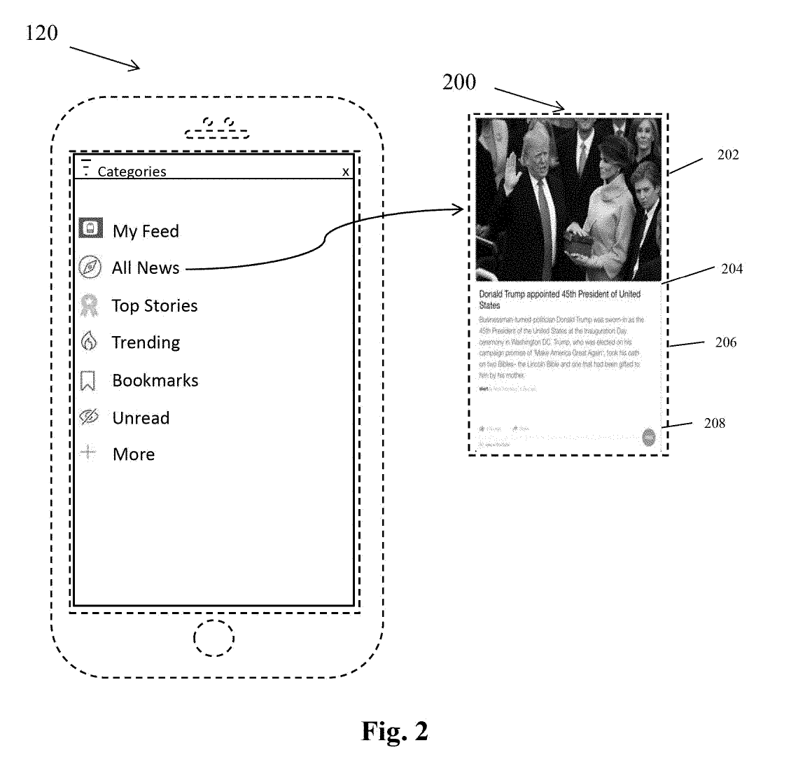

Such news content usually includes an image, a headline of the news, and the summary of the news item. Exemplary news content in the predefined format is shown in FIG. 2.

Referring to FIG. 1, there is shown a system 100 for the implementation of the methods for digital content broadcasting in a communication network. There is shown the system 100 comprising a digital content generating server 110 at the end of a content service provider providing such kind of short news content or other like services. Further, there is shown a computing device 120 of a first user and a plurality of computing devices 130 of plurality of users 125a subscribed to the services provided by the content service provider. All are linked through a communication network 140, which could be wired or wireless communication network.

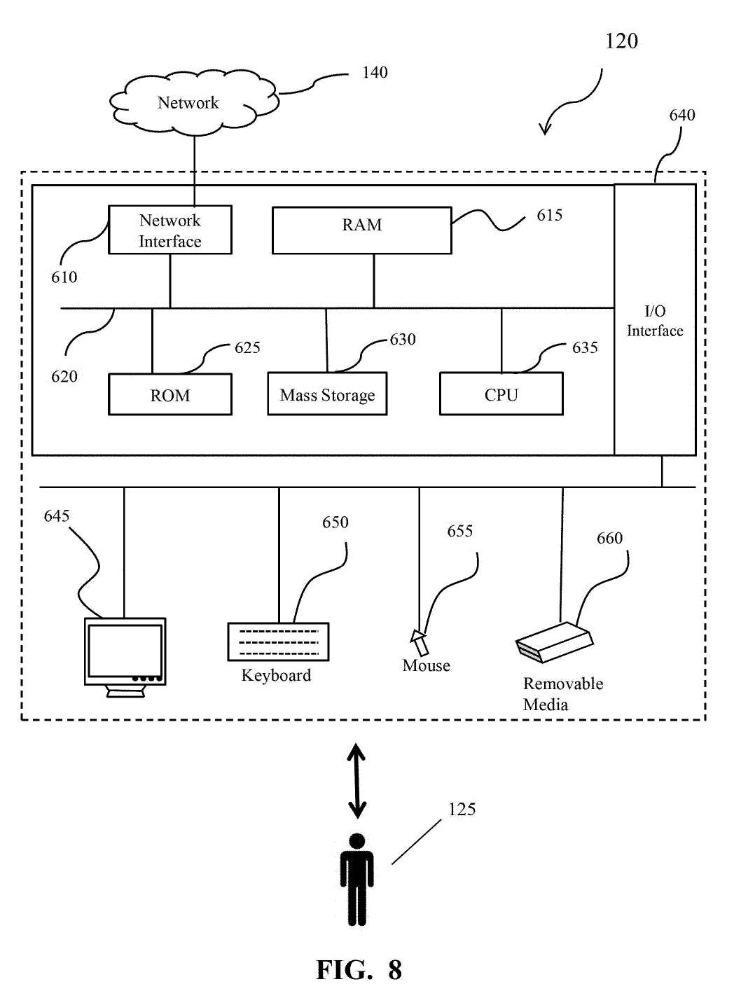

It will be apparent to a person skilled in the art that the computing device herein refers to any processing device, and may include mobile phones, smart phones or PDAs, Tablet computers and the like. Such computing devices comprise a memory, a display screen, an input/output unit and a processor capable of executing instructions for accessing a digital content broadcasted by the digital content server. These computing devices have a software application provided by the content service provider. In one embodiment, a computing device is a smart phone, such as iPhone, with a mobile phone application pre-installed or custom installed by the subscribers. The architecture of computing devices 120, 130 is shown and explained with reference to FIG. 8.

The digital content server 110 is at the content service provider end and is adapted to generate and transmit digital contents. Referring to FIG. 2, in one embodiment, the digital content is a news content which comprises a summary of a larger news item. The news content comprises an image, headline of the news, and the summary of the news content, as shown with reference to FIG. 2.

In an embodiment of the present disclosure, the digital content server 110 may be adapted to automatically generate the news content 200 using artificial intelligence algorithms.

In an embodiment, the present disclosure employs human interface who hold expertise in redacting and shortening long article into short and precise one to make the news content 200, as shown in FIG. 2.

As aforesaid, these days various kinds of digital contents or news contents are available on the web. The news content may relate to any kind of information such as news relating to sports, world, politics, technology, entertainment, science and much more. The content may also relate to any interesting facts around the world. Such kind of information is available in vast quantities on the World Wide Web.

However, it will be appreciated by a person skilled in the art that such information is generally in the form of long reports reading which is time consuming for a user. There are many details in these reports, which may be irrelevant to the user. A user may only be interested to read the relevant portion of such information. Therefore, these artificial intelligence algorithms may be adapted to generate a summarized content (short news content) automatically by parsing the information to produce the short news content based on computing algorithms. The short news content may be in a predefined format (picture, headline and summary) as shown in FIG. 2.

In another embodiment, the present disclosure may employ human interface who holds expertise in redacting and shortening long article into short and precise one to make the short news content, as shown in FIG. 2. In this case, human resources may be used to create the short news content.

As shown in FIG. 2, there is shown exemplary short news content 200 on the first user device 120. The short news content 200 comprises an image 202, a headline 204 of the news and summary of the news 206 in a preset number of words or less.

However, it should be understood by the person skilled in the art that the digital content should not be construed to be restricted to the one disclosed with reference to news content 200. The digital content may comprise any form of textual content, an image content, a video content, an audio content, or a Graphics Interchange Format (GIF).

The digital content server 110 is further adapted to store each of the news content 200 in a database with a unique content_id associated with each news content 200. This unique content_id is created by the digital content server 110 for each of the news content 200 as and when required.

It will be appreciated to those skilled in the art that a user may read/view the digital content via execution by a software application which is pre-installed on the computing devices 110. Such software application may be compatible to any of the operating systems known in the art, such as Android OS, Windows OS or iOS, and may be downloaded on the computing devices 110 from application stores such as Google Play Store, App Store.

Each computing device 110 is assigned a specific and unique device_id by the digital content server 110 and this device_id is stored in a database at the digital content server 110. An example is provided in the below table:

| User | Device_id | Mobile |
|---|---|---|
| John | John123 | XXXXXXXXXX |
| Alex | Alex456 | YYYYYYYYYY |
| Sam | Sam789 | ZZZZZZZZZZ |

In an embodiment, the mobile number of the user is also stored along with the unique device_id of the computing device belonging to that particular user.

It will be appreciated to those skilled in the art that a user may read/view the digital content via execution by a software application which is pre-installed on the computing devices 120, 130 of the users 125, 125a. Such software application may be compatible to any of the operating systems known in the art, such as Android OS, Windows OS or iOS.

Once the software application is installed in a computing device, the application prompts the user to register for the services. During registration, the application prompts the user to allow access to the contacts stored in the phonebook of the computing device, allow access to social media contacts such as Facebook and Twitter. In a manner, the contacts stored in the phonebook of the computing device of the user and the social media contacts become available at the digital content server.

Referring again to FIG. 1, the present systems and methods provide means for allowing a first user 125 via his computing device 120 for broadcasting the digital content to one or more of plurality of user devices 130 of users 125a.

It will be appreciated to a person skilled in the art that now-a-days, generally people are lot more interested in sharing digital contents to their friends, family or colleagues and others. Therefore, the first user 125 may be interested in sharing the news content 200 that he may be reading and/or likes, to one or more of the plurality of users 125a who are subscribed to the services of the content service provider 110. The present systems and methods allow the first user 125 to share/broadcast the digital content among a selected set of users 125a based on a predefined criteria.

In an embodiment of the present invention, the predefined criteria comprises sharing the digital content (news content) with the one or more of the users 125a whose contacts are present in the contact database of the computing device 120 (or smart phone 120) of the first user 125, and who are also subscribed to the services provided by the content service provider.

It will be appreciated by a person skilled in the art that in the computing device 120 of the said first user 125, there may be contact information stored in the contact database of the computing device 120. Among these contacts, there may be one or more of the computing devices 130 or subscriber devices 130 which are subscribed to the services of a content service provider 110. These subscriber devices 130 may have the same software application installed on the computing devices 130.

In one embodiment, the computing device 120 of the first user 125 and each of the computing devices 130 comprise an executable program 122 to automatically select the contacts from the contact database of the computing device 120 of the first user 125 and then broadcast the digital content (news content) to the one or more users of the users 125a. In a manner, the one or more plurality of users 125a may also act as the first user 125. It should be understood that the explanation with reference to first user 125 in the manner described in this patent applications is exemplary, and accordingly the systems and method disclosed allow broadcasting of news content 200 from any of the users 125a to any other users 125a.

In another embodiment of the present disclosure, the predefined criteria comprises sharing digital content to one or more of the users 125a that are social media contacts of the first user 125.

It will be appreciated by a person skilled in the art that a first user 125 may have plurality of social media accounts 115, 117, 119 such as Facebook, Twitter, LinkedIn and the like.

More specifically, the executable program 122 is such that it provides the said first user 125 with an option to initiate broadcasting of the digital content using a single click, via his computing device 120.

On any such initiation input of a single click from the first user 125, in one embodiment of the disclosure, the executable program 122 is configured to send the request for broadcasting the news content 200 to the digital content server 110.

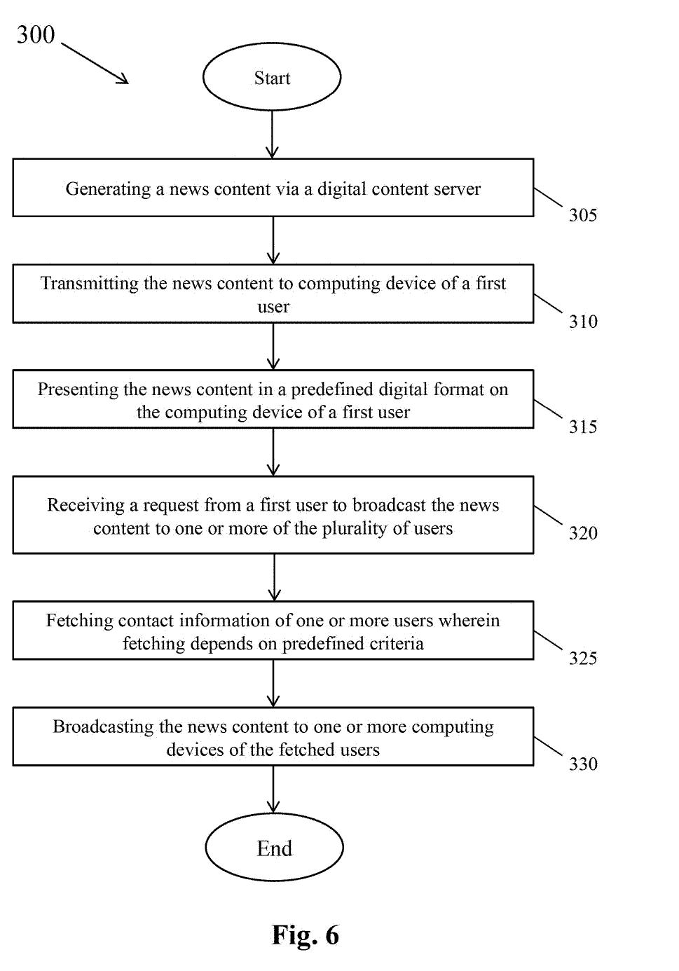

At the digital content server 110, upon receipt of the request for broadcasting news content 200, there are methodologies followed for segregating the contacts to whom the news content 200 is to be broadcasted are carried out. This will be explained in detail in con junction with the FIG. 6.

The news content 200 broadcasted by the first user 125 is notified in the software application in the computing devices 130a, 130c, 130d, 130f, and 130g belonging to one or more users 125a who are subscribed to the services of the content service provider.

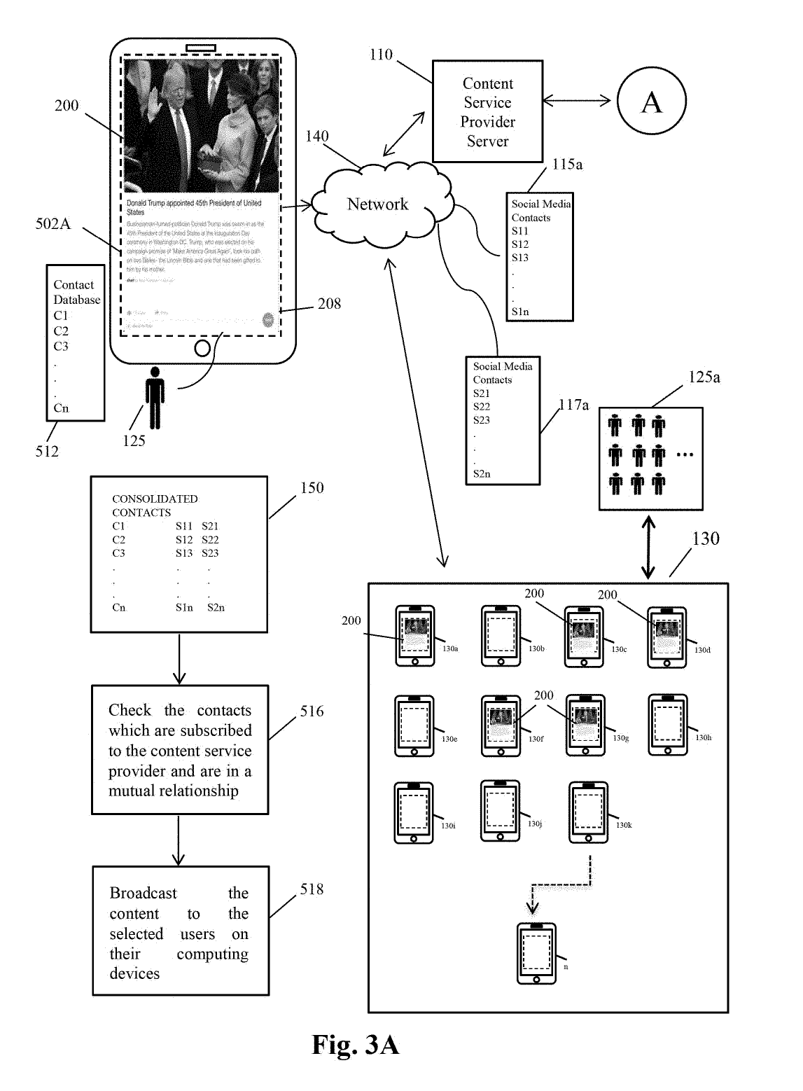

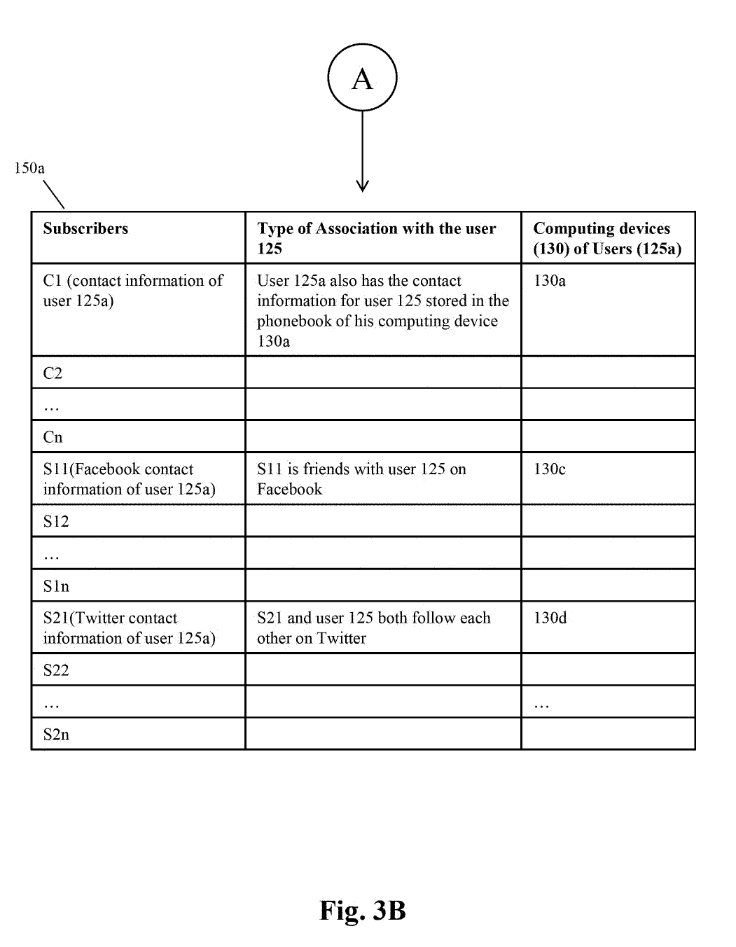

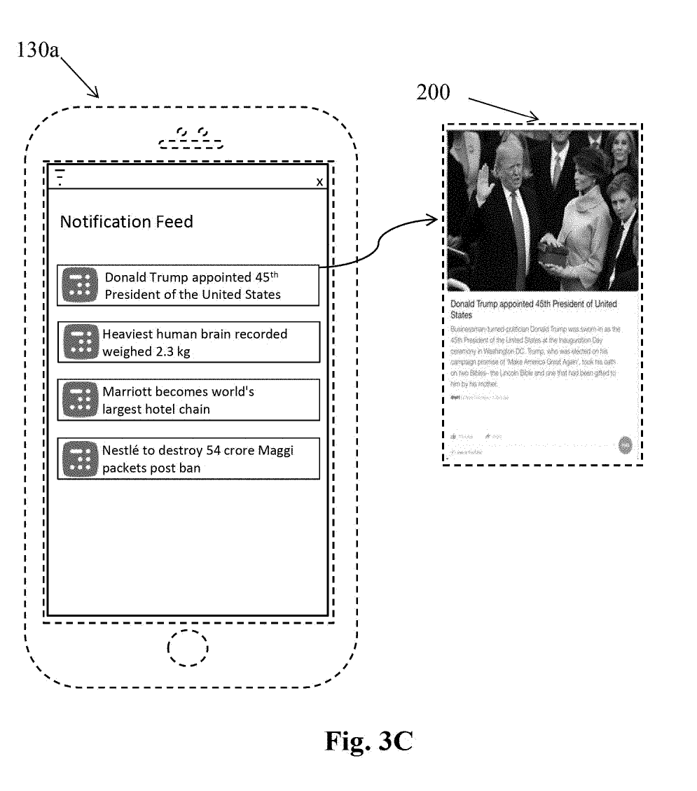

The news content 200 is then displayed on the computing devices 130 of the one or more of the plurality of users 125a. It will be appreciated that the users 125a are not required to follow any hyperlink/URL to access the news content which is broadcasted by the first user 125, but access the news content 200 in totality directly in their software applications of computing devices 130. These aspects will be explained in detail with reference to FIG. 3A.

Referring now to FIGS. 3A and 3B, there is shown a schematic diagram for broadcasting the news content 200 to the computing devices 130 of the one or more users 125a in a communication network. As shown, a first user 125 possesses the computing device 120. The said first user 125 has news content 200 transmitted by the content provider server 110 being received on his computing device 120 using the software application installed on the computing device 120.

The said news content 200 is presented on the display screen of the said computing device 120, as shown in the FIG. 3A, in its user interface 502A. As shown in FIG. 3A, there is also provided a TOSS button 208 on the user interface or UI 502A of the software application. The first user 125 has the option of choosing this button on the said UI 502A if the first user 125 wishes to share/broadcast the said news content 200 to computing devices 130 belonging to one or more of the plurality of users 125a. The TOSS button features a single click method for broadcasting the news content.

Once the first user 125 makes a single click selection of the said TOSS button 208, the execution program 122 is initiated and the request for broadcasting is sent to the digital content server.

At the end of the digital content server, a consolidated database 150 of contacts comprising the contacts 512 from the contact database and the contacts 115a, 117a from social media accounts is prepared.

In an embodiment, these contacts are checked for those who are subscribed to the services provided by the content service provider and who are associated with the contacts of the first user.

Thereafter, the news content 200 is broadcasted to such contacts and a notification is sent to computing devices of each of such contacts.

In one embodiment of the present disclosure, the content service provider 110 identifies a unique identifier, such as a mobile phone number; with each contact in the consolidated contacts list in a master database 150a to determine which of the computing devices 130 are subscribers to the services of the content service provider 110. The master database includes a list of subscribers with their details, such as mobile numbers, email addresses or other such unique identifying information.

Furthermore, the content service provider 110 confirms whether the said identified one or more of the computing devices 130 have the software application installed on their computing devices 130 for reading/viewing the received digital content. It should be noted that such identification could also be based on other identifiers, such as email address, or the like, used by the users 125a to subscribe to the services of the content service provider server 110.

In an embodiment, the content service provider 110 is configured to determine whether the first user 125 and the users 125a are related to each other and share a mutual relationship. Referring to FIG. 3B, there is shown a table 150a, describing the various types of association or mutual relationship between the first user 125 and the one or more of the plurality of users 125a. In the said table 150a, there are three exemplary columns namely Subscribers, Type of Association with the user 125 and computing devices (130) of Users (125a). Taking the first example where C1 represents the contact information of user 125a which is stored in the computing device 120 belonging to user 125. User 125a also has the contact information for first user 125 stored in his computing device 120. Such presence of each other's contact information in their respective computing devices is considered as a mutual relationship according to the algorithms of the present disclosure.

In an embodiment, the unique device_id of each of the computing devices for each of the contacts is stored with each of the contact details in the database.

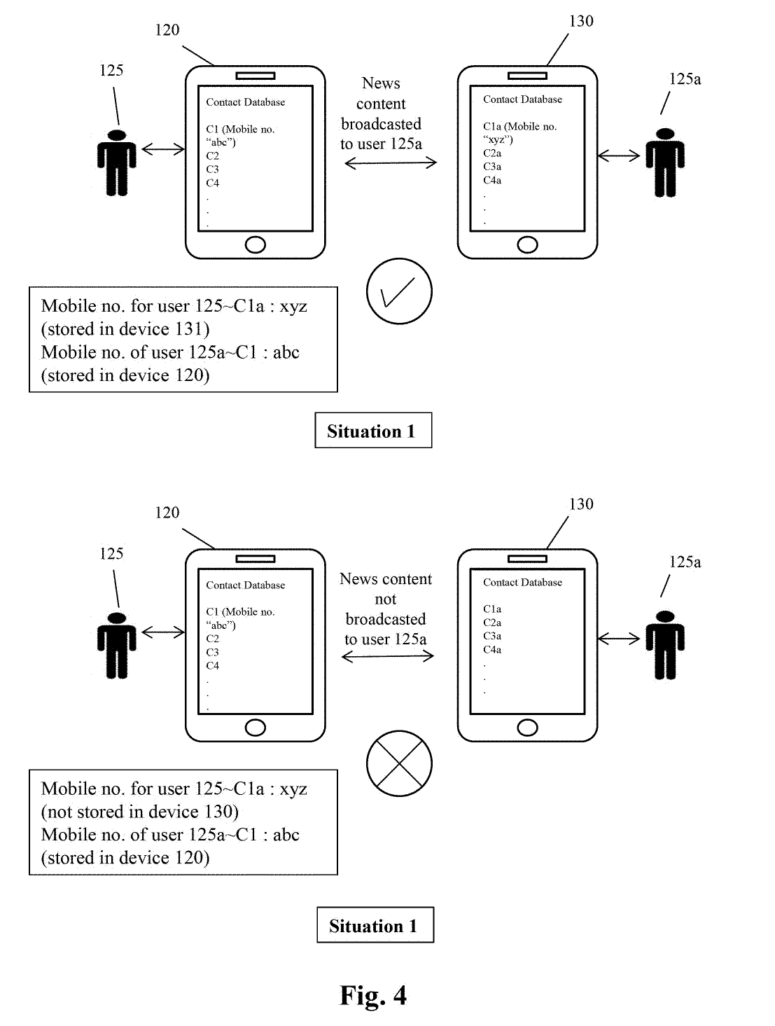

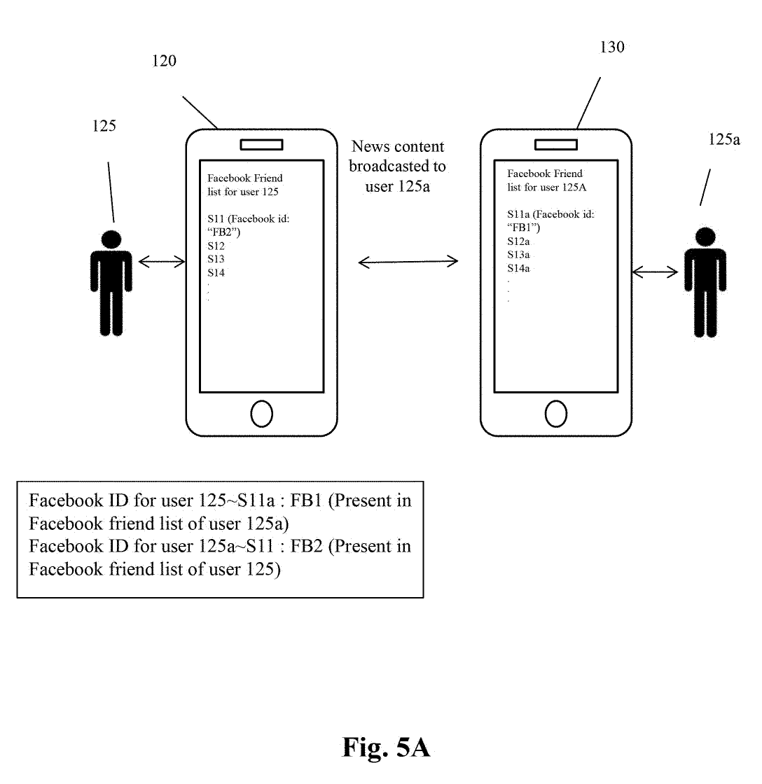

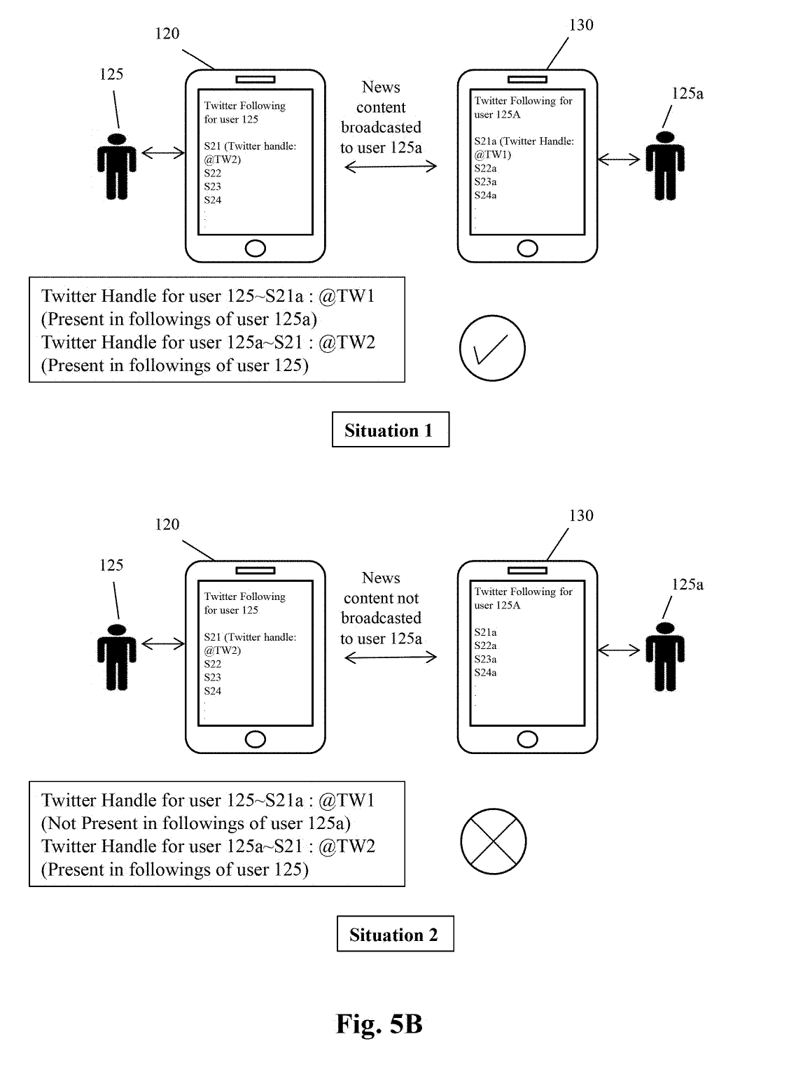

Referring again to FIG. 3A, the first user 125 shall be considered having a mutual relationship with the one or more of the plurality of users 125a based upon the below criteria:
1. Whether the contact information of the first user 125 and the one or more of the plurality of users 125a are stored in their respective computing devices 120 and 130, as shown in FIG. 4 (shall be explained in detail later);
2. Whether the first user 125 and the one or more of the plurality of users 125a follow each other on social media platforms like Twitter, etc., as shown in FIG. 5A (shall be explained in detail later);
3. Whether the first user 125 and the one or more of the plurality of users 125a are friends with each other on social media platforms like Facebook, as shown in FIG. 5B (shall be explained in detail later).

The above mentioned criteria are meant for explanation purposes only and these should not be construed as a limitation to the above mentioned criteria.

After the confirmation, the news content 200 is broadcasted to those one or more of the plurality of users 125a. The said news content 200 is then presented on the computing devices 130 of the plurality of users 125a in the same predefined format. Referring to FIG. 3A, there is shown that the news content 200 is broadcasted to devices 130a, 130c, 130d, 130f, and 130g.

In one embodiment, the broadcasted news content 200 may be received in the notification feed in the computing devices 130 belonging to the one or more users 125a, and the one or more users 125a may access the news content 200 directly by clicking on the received notification in the notification feed, as shown in FIG. 3C, which shows the news content 200 being received in the notification feed of the computing device 130.

In an embodiment of the present disclosure, among the various contacts in the consolidated contact 150, if any one of the contacts has already read the news content 200 which the first user 125 wants to broadcast, then this news content 200 is not broadcasted to that user. It may happen that multiple users (125, 125a) in the communication network receive the same news content 200 transmitted by the content service provider 110 and one of the users 125 decides to broadcast the same. Further, the one or more of the users 125a might have already read the news content 200. In such cases, the content service provider 110 is configured to check whether a user 125a from the consolidated contacts 150 has already read the news content 200. If yes, then the news content 200 is not broadcasted to that user. If no, then the news content 200 is broadcasted to the user 125a.

Now referring to FIG. 6 of the drawings, there is shown a flowchart for a method 300 for digital content broadcasting among a plurality of users having computing devices, the plurality of users are subscribed to a content service provider and have software application capable of reading the news content in the predefined digital format.

In an embodiment, the computer-implemented method 300 comprises a processor executable set of instructions capable of broadcasting news content to multiple users on a single click request from a first user.

At step 305, the method 300 is adapted to generate a digital content, such as news content 200, via a digital content server 110. The digital content server 110 is the server which is usually located remote to the plurality of users 125a in the network. The digital content server 110 is adapted to generate the digital content and transmit the same to a plurality of users.

In an embodiment, the digital content server 110 is adapted to automatically generate digital contents such as short news content from long and lengthy news articles.

In another embodiment, there are human interfaces for generating the short news content.

In an embodiment, the said news content comprises an image, a headline of the news and summary of the news, as shown in FIG. 2.

In an embodiment, the news content comprises at least one textual content, an image content, a video content, an audio content, or a Graphics Interchange Format (GIF).

At step 310, the news content 200 is transmitted to a computing device of the first user. The explanation of the method 300 is being done using reference to a first user. However, this should not be construed as a limitation of the present disclosure. The news content 200 is transmitted to a plurality of users in the network who are subscribed to the services provided by the content service provider.

At step 315, the news content 200 is presented to on the computing device of the user.

After reading the news content 200 in the computing device, a first user may find the news content 200 to be interesting and desire to share with his friends, colleagues or family and others. At step 320, the first user clicks on the “TOSS” button (refer FIG. 2, 208) on the user interface of the software application on his computing device 120.

Once the click is made, at step 325, a request for broadcasting is sent to the digital content server 110 where the said request is identified with the device_id of the computing device from which the request has been sent.

Upon such request, the digital content server 110 is configured to fetch contact information of a plurality of users who are associated with the first user.

As explained earlier, when a user registers to the services provided by the content service provider, the computing device transmits all the information to the digital content server. The information comprises contacts stored in the phone book of the computing device and social media contacts.

At the end of the computing device, in an embodiment, a consolidated database 150 of contacts comprising the contacts 512 from the contact database and the contacts 115a, 117a from social media accounts is prepared. This consolidated database is updated from time to time whenever any new contact is added to contact database or the social networking accounts. Moreover, the execution program installed at the computing device is adapted to provide information to the digital content server when any new contact is added to the contact database or the social networking accounts.

In an embodiment, the contacts in the consolidated database are checked for those who are subscribed to the services provided by the content service provider and who are associated with the contacts of the first user.

Thereafter, the news content 200 is broadcasted to such contacts at step 330 and a notification is sent to computing devices of each of such contacts.

In an embodiment of the present disclosure, the present systems and methods are adapted to check whether the first user 125 and the one or more of the plurality of users 125a share a mutual relationship with each other. In a way, the first user 125 and the one or more of the plurality of users 125a should be friends in order to receive the digital content broadcasted by the first user 125. The criteria for the mutual relationship shall be explained in conjunction with FIGS. 4, 5A and 5B.

In an embodiment, the said news content 200 is presented in a predefined format on the computing device of the one or more plurality of users. The digital content is short news content comprising an image, a headline of the news and the summary of the news item. This however should not be construed as a limitation; there may be other formats for such displaying of the digital content on the computing device of users.

In an embodiment of the present disclosure, if the software application capable of reading/viewing the digital content is not present in the computing devices 130 for the one or more of the plurality of users 125a, then the present systems and methods are capable of sending SMS to their respective mobile numbers. The said SMS may comprise a URL for the digital content. The recipient user 125a may click on the said URL and view/read the digital content over a web browser.

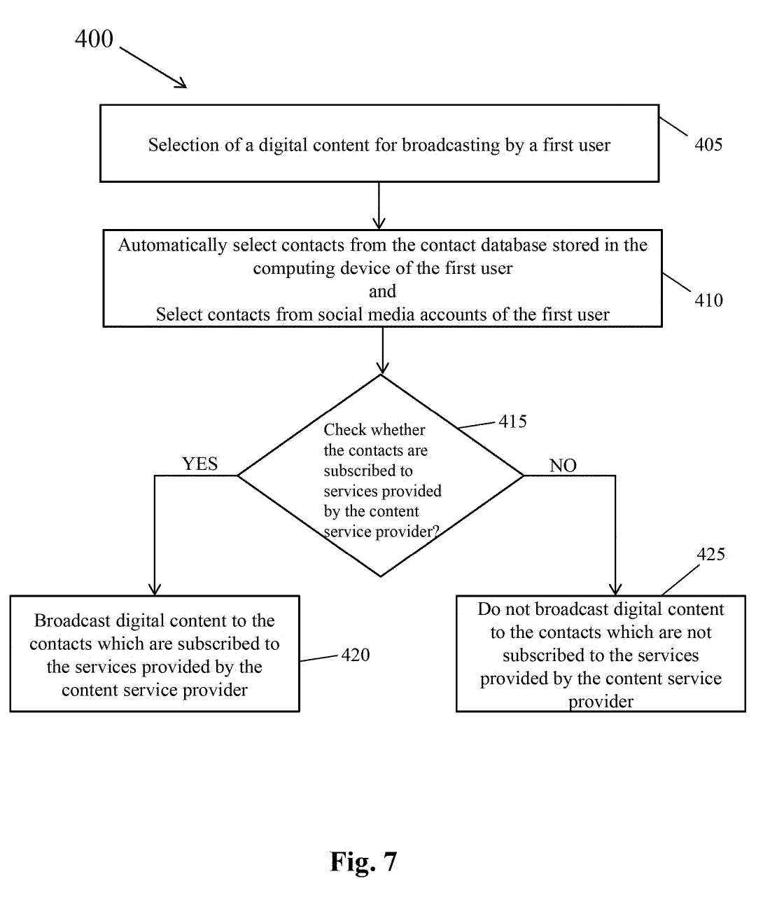

Referring to FIG. 7, there is illustrated a flowchart for a method 400 regarding the selection of contacts to whom a selected digital content is to be broadcasted. The method 400 begins at step 405, where a first user selects a digital content or news content 200 via his computing device 120 for broadcasting to one or more plurality of users 125a in the network. The said news content 200 has been transmitted via a digital content generating server to the computing device 120 of the first user 125. This has already been explained in conjunction with FIG. 6 of the accompanying drawings.

At step 410, the method 400 is adapted to retrieve the contacts stored in the contact database of the computing device 120 of the first user 125. The method 400 is also adapted to retrieve the social media contacts 115a, 117a, 119a of the first user 125. At step 415, the method 400 is adapted to check and find those contacts which are subscribed to the services provided by a content service provider 110. The selected digital content or news content 200 is broadcasted to only those contacts which are subscribed to the services provided by a content service provider 110 at step 420.

In an embodiment, the selected news content 200 is broadcasted to the computing device 130 of one or more plurality of users 125a in the network. It is further explained that these plurality of users 125a are capable of broadcasting digital contents which they read/view on their computing devices 130. In a manner, this plurality of users 125a may act as first user 125.

At step 425, the contacts which are not subscribed to services provided by the content service provider are rejected and the digital content is not broadcasted to such users.

Referring to FIG. 4, in an embodiment of the present disclosure, the news content 200 selected for broadcasting by the first user 125 is broadcasted to the one or more of the plurality of users 125a if the contact information of the first user 125 and the one or more of the plurality of users 125a is stored in their respective computing devices 120 and 130. For example, if the mobile number of the first user 125 is “xyz” and the mobile number of one of the users 125a is “abc”, and computing device of first user 125 is 120 and the computing device of one of the users 125a is 130, then the mobile number “xyz” should be stored in the computing device 130 and mobile number “abc” should be stored in computing device 120. According to Situation 1 as shown in FIG. 4, both the computing devices 120 and 130 have the contact information stored for users 125a and 125 respectively. Hence, in this situation, the news content 200 selected for broadcasting by user 125 is broadcasted to the user 125a.

To the contrary, in situation 2 of the FIG. 4, the contact information of user 125 is not stored in the computing device 130 of the user 125a whereas the contact information of user 125a is stored in the computing device 120 of the user 125. In such situation, the news content 200 selected for broadcasting by user 125 is not broadcasted to the user 125a.

FIG. 5A of the drawings illustrates an embodiment of the present disclosure where the first user 125 and the one or more of the plurality of users 125a are friends with each other on social media platform such as Facebook and the like. The present systems and methods are adapted to perform a check whether the one or more of the plurality of users 125a are friends with the first user 125. The news content 200 selected for broadcasting by user 125 is broadcasted to the user 125a if both user 125 (˜FB1) and user 125a (˜FB2) are present in each other's friend list in their Facebook account.

FIG. 5B of the drawings illustrates an embodiment of the present disclosure where the first user 125 and the one or more of the plurality of users 125a follow each other on social media platform such as Twitter and the like. According to situation 1 as shown in FIG. 5B, the twitter handle @TW1 for user 125 is listed among the followings of user 125a and the twitter handle @TW2 for user 125a is listed among the followings of user 125. In such cases, the news content 200 selected for broadcasting by the first user 125 is broadcasted to the user 125a.

Now moving to situation 2 in FIG. 5B, the twitter handle @TW1 belonging to user 125 is not followed by the user 125a whereas the twitter handle @TW2 belonging to user 125a is followed by the user 125. In such situation, the news content 200 selected for broadcasting by the first user 125 is not broadcasted to the user 125a.

The above mentioned criteria are meant for explanation purposes only and these should not be construed as a limitation to the above mentioned criteria.

For some of the major algorithms described in the above description, a “pseudocode” version of the algorithm is provided. “Pseudocode” is, essentially, a computer language using universal computer language conventions meant for human understanding. While the pseudocode employed here has been invented solely for the purposes of this description, it is designed to be easily understandable to any person skilled in the art.

@QUERY_MUTUAL_CONTACTS: Returns precomputed mutual contact list for given user_id
@QUERY_COMPUTING_DEVICES: Returns list of computing devices the give user is using
@NOTIFY_DEVICE: Notifies the device that he has been TOSSED News ‘news_id’ by user

‘user_id’

@SPAMCHECK: An optional check to ensure that the user is not spammed by tosses

######################### INVOCATION METHODS ########################

def TOSS(from_user_id,to_user_id,news_id):

# optional spam control check

if SPAMCHECK(from,to,news_id) == ‘SPAM’:

#do not toss to this contact if this toss will spam him/her

Return

computing_devices =QUERY_COMPUTING_DEVICES(to) for device in computing_devices:

NOTIFY_DEVICE(device)

def invoke(user_id, news_id):

mutual_contact_list = QUERY_MUTUAL_CONTACTS(user_id)

for contact_id in mutual_contact_list:

TOSS(user_id, contact_id, news_id)

##################### DEVICE SIDE INSTRUCTION #######################
Device will call ** invoke(user_id,news_id) ** and the above methods will be executed

user_id : it is a unique identifier to identify particular subscribed user
news_id : it is a unique identifier to identify particular news published

The present systems and methods are capable of providing news content to a user and thereby allowing the user to share the digital content with other users in a single tap or click. The present systems and methods are capable of transmitting and presenting the news content in a specific format. Moreover, the news content is displayed on the computing device in the said format where there is no need for a user to click on a certain URL and read the news. Additionally, the present system and method are configured to broadcast a news content selected for broadcasting by a user to various categories of contacts such as phone book contacts, social media contacts and the like.

FIG. 8 illustrates the architecture of computing devices 120, 130. The said architecture comprises a network interface 610, a Random Access Memory (RAM) 615, a Read only Memory (ROM) 625, a Mass Storage 630, a Central Processing Unit (CPU) 635 and an Input/Output interface 640. The I/O interface 640 is further coupled with a display unit 645, a keyboard 650, a mouse 655 and a removable media 660. The said computing device is connected to the network 140 with the help of network interface 610. These should not be taken as a limitation of the disclosed computing device as there may be additional components in the architecture.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

We claim:

1. A computer implemented method for broadcasting a digital content among a plurality of computing devices of users, the plurality of users are subscribed to a digital content service provider, the method allowing a user to broadcast the digital content in single tap or click, the method comprising:
generating a digital content via a digital content server, the said digital content generated in a predefined digital format;
transmitting the said digital content to a computing device of a first user;
presenting the said transmitted digital content on the computing device of the first user, the presenting being done in the predefined digital format;
receiving a request from a computing device of a first user to broadcast the digital content to one or more of the plurality of computing devices of users;
fetching contact information of the one or more users associated with the first user, wherein the fetching is based upon a predefined criteria; and
broadcasting the digital content to the computing devices of the fetched one or more users.

2. The computer implemented method as claimed in claim 1, wherein the digital content server is adapted to generate the digital content in the said predefined digital format, the digital content being generated from information available on the world wide web.

3. The computer implemented method as claimed in claim 1, wherein the digital content is short news content comprising a summary of larger news content.

4. The computer implemented method as claimed in claim 3, wherein the short news content comprises an image, a headline of the news, and the summary of the news item.

5. The computer implemented method as claimed in claim 1, wherein the digital content comprises at least one textual content, an image content, a video content, an audio content, or a Graphics Interchange Format (GIF).

6. The computer implemented method as claimed in claim 1, wherein the computing device is a smart phone.

7. The computer implemented method as claimed in claim 6, wherein the predefined criteria comprises contact information of one or more users which are stored in contact database of the smart phone of the first user.

8. The computer implemented method as claimed in claim 1, wherein the predefined criteria comprises contact information of one or more users who are in social media contacts of the first user.

9. The computer implemented method as claimed in claim 7, wherein the social media contacts are Facebook contacts and Twitter contacts of the first user.

10. The method as claimed in claim 1 further comprising storing the contact information of the contacts associated with the first user in a database at the digital content server.

11. The computer implemented method as claimed in claim 1 comprising presenting the digital content on the computing device of the one or more users in the said predefined format.

12. A system for broadcasting a digital content among a plurality of users subscribed to the services provided by a digital content service provider in a single tap or click, the system comprising:
a plurality of computing devices capable of being operated by the users, each computing device comprising an execution program for receiving and presenting the digital content; and
a digital content server communicably coupled to the plurality of computing device of users, the digital content server comprises one or more processors adapted to execute instructions for,
generating a digital content, the said digital content generated in a predefined digital format,
transmitting the said digital content to a computing device of a first user,
presenting the said transmitted digital content on the computing device of the first user, the presenting being done in the said predefined digital format,
receiving a request from a computing device of the first user to broadcast the digital content to one or more of the plurality of computing devices,
fetching contact information for one or more users associated with the first user, wherein the fetching is based upon predefined criteria, and
broadcasting the said digital content to the computing devices of the fetched one or more users.

13. The system as claimed in claim 12, wherein the digital content server is adapted to generate the digital content in the said predefined digital format, the digital content being generated from information available on the world wide web.

14. The system as claimed in claim 12, wherein the digital content is short news content comprising a summary of larger news content.

15. The system as claimed in claim 14, wherein the short news content comprises an image, a headline of the news, and the summary of the news item.

16. The system as claimed in claim 12, wherein the digital content comprises at least one textual content, an image content, a video content, an audio content, or a Graphics Interchange Format (GIF).

17. The system as claimed in claim 12, wherein the computing device is a smart phone.

18. The system as claimed in claim 17, wherein the predefined criteria comprises contact information of one or more users which are stored in contact database of the smart phone of the first user.

19. The system as claimed in claim 12, wherein the predefined criteria comprises contact information of one or more users who are in social media contacts of the first user.

20. The system as claimed in claim 19, wherein the social media contacts are Facebook contacts and Twitter contacts of the first user.

21. The system as claimed in claim 12 further comprising storing the contact information of the contacts associated with the first user in a database at the digital content server.
